(19) United States
(12) Patent Application Publication
(10) Pub. No.: US 2014/0167693 A1
(43) Pub. Date: Jun. 19, 2014

(54) MOUNTING SYSTEM FOR CHARGING EQUIPMENT

(71) Applicant: GENERAL ELECTRIC COMPANY, Schenectady, NY (US)

(72) Inventors: Michael Wood, Plainville, CT (US); Javier I Larranaga, Plainville, CT (US); Brian Mooney, Plainville, CT (US); Cecil Rivers, JR., Plainville, CT (US)

(73) Assignee: GENERAL ELECTRIC COMPANY, Schenectady, NY (US)

(21) Appl. No.: 13/719,469

(22) Filed: Dec. 19, 2012

(51) Int. Cl. H02J 7/00

(52) U.S. Cl. CPC H02J 7/00
USPC 320/109; 320/107

(57) ABSTRACT

A surface mountable charging device connectable to a power receptacle for charging an electrically powered vehicle is disclosed. The charging device comprises a housing and a first locking portion defining a first locking aperture. The device also comprises an electric charging circuit to supply current to an electric vehicle power storage device, and includes a power connector electrically coupled to the electric circuit, configured for a releasable electrical connection with the power receptacle. The device further includes a mounting base mountable to the mounting surface, comprising a first coupling portion defining a coupling aperture to operatively receive the power connector. The mounting base also comprises a second locking portion defining a second locking aperture. The housing is coupled to the mounting member and the first and second locking apertures cooperate with a locking element to prevent a de-coupling of the housing from the mounting member.

### BACKGROUND OF THE INVENTION

The subject matter disclosed herein relates generally to mounting systems and methods and, more particularly, to mounting systems and methods for electric charging stations removably coupled thereto.

Electrically powered vehicles, including electric vehicles and plug-in hybrid electric vehicles, include electric motors powered by energy storage devices, such as batteries. Because an energy storage device is depleted of energy as the vehicle is operated, the operator of the vehicle must recharge the energy storage device prior to using the vehicle again.

At least some known vehicle charging devices or stations are provided for use in various environments. Such charging stations are designed to charge electrically powered vehicles, while providing security and protection for components utilized in charging the vehicle. Charging stations include a variety of constructions to hold up to the environments in which the charging stations are installed. For example, various known charging stations are intended to be removably mounted to a substantially vertical solid surface, such as a wall or pole. Maintenance and/or service of such charging stations often involve removal of the charging station from the mounting surface to gain access to components included therein. It would be desireable to provide a low-cost device and system to enable removably mounting a charging station to a solid surface.

The electric vehicle supply equipment (EVSE), which is also referred to as supply equipment, a vehicle charger, a charging station, a charger, a charging device, etc., may be realized in several different mechanical configurations. EVSE are frequently installed as wall or surface-mounted units in garages and on buildings where vehicles can be parked inside or close to the building. Such wall-mounted units are conventionally fastened to a wall or other vertical surface, either directly or via a mounting bracket. Additionally, the wall mounted EVSE are also typically arranged as “plug-in” type units configured to plug in to a receptacle or wall mounted outlet.

The Society of Automotive Engineers (SAE) J1772 standard defines different types of charging including for example AC Level 1, which utilizes a common 120 Volt, 15 Amp grounded receptacle, and AC Level 2, which utilizes a dedicated AC power connection at 208-240 Volts nominal and 32 Amps maximum. DC charging is defined as a method that utilizes dedicated direct current (DC) supply equipment.

Conventional charging stations such as may be used in residential applications may have a relatively high current draw from the electrical distribution system to the EVSE. In certain regions, electrical codes such as the National Electrical Code (NEC) require EVSE to be permanently connected to the electrical distribution system if the operating voltage of the EVSE is above 120V. For example, such EVSE units are typically plugged in, such as with a power connector, for example a NEMA 6-50 plug, into a conventional receptacle wired to receive power from a 220/240VAC supply, such as the utility grid or other source. Such a permanent connection is intended to prevent a user from making and breaking high voltage and current, for example by disconnecting the EVSE plug connector from the power receptacle, when the EVSE is charging.

It is desirable to provide a convenient way of connecting the Level I or Level II electricity source to an electric vehicle to recharge the batteries thereby making recharging quicker and using an electric vehicle more practical. It is also desirable to provide a convenient way to plug the electric vehicle supply equipment to either a Level I or Level II electrical supply source using plugs and receptacles designed to meet National Electrical Manufacturers Association (NEMA) standards, and with minimal duplication of components. It would be desirable for a device and/or system to enable easy low cost installation for a plug-in type EVSE.

It would also be desirable to enable pre-wiring of a residential outlet to enable ready installation of an EVSE. Such pre-wiring would further enable portability of EVSE equipment by an owner from one residence to another.

It would also be desirable to enable a direct connection of an EVSE to an existing outlet, without the need for wire and plug

It would further be desirable to eliminate the need for a “locking cover” on an outlet or receptacle to prevent disconnection while charging

### BRIEF DESCRIPTION OF THE INVENTION

In one aspect, an electric vehicle charging device, mountable to a mounting surface and connectable to a power receptacle is disclosed. The charging device comprises a housing comprising an interior portion, and a first locking portion defining a first locking aperture therethrough. The device also comprises an electric charging circuit disposed at least partially within the housing interior portion and is configured to supply a charging current to an electric vehicle power storage device. The device also includes a power connector electrically coupled to the electric circuit, comprising an end portion configured for a releasable electrical connection with the power receptacle. The device further includes a mounting base configured to be mounted to the mounting surface comprising a first coupling portion defining a coupling aperture therethrough, and sized and disposed to operatively receive the power connector. The mounting base also comprises a second locking portion defining a second locking aperture therethrough. Additionally, the housing is configured to be operatively coupled to the mounting member and the first and second locking apertures are sized and disposed to cooperate with a locking element to prevent a de-coupling of the housing from the mounting member.

In another aspect, a system an electric vehicle charging system, mountable to a mounting surface and connectable to a power receptacle is disclosed. The charging system comprises a housing comprising an interior portion, and a first locking portion defining a first locking aperture therethrough. The system also comprises an electric charging circuit disposed at least partially within the housing interior portion and is configured to supply a charging current to an electric vehicle power storage device. The system also includes a power connector electrically coupled to the electric circuit, comprising an end portion configured for a releasable electrical connection with the power receptacle. The system further includes a mounting base configured to be mounted to the mounting surface comprising a first coupling portion defining a coupling aperture therethrough, and sized and disposed to operatively receive the power connector. The mounting base also comprises a second locking portion defining a second locking aperture therethrough. A locking element is disposed within the first and second locking apertures. Additionally, the housing is configured to be operatively coupled to the mounting member and the first and second locking apertures are sized and disposed to cooperate with the locking element to prevent a de-coupling of the housing from the mounting member.

### BRIEF DESCRIPTION OF THE DRAWINGS

FIG. 1 is a schematic diagram of a charging system according to an exemplary embodiment.

FIG. 2 is a view of a mounting base of the charging system of claim 1.

FIG. 3 is a perspective exploded view of an embodiment of an exemplary charging device.

FIG. 4 is another perspective exploded view of an embodiment of an exemplary charging device.

FIG. 5 is another perspective exploded view of an embodiment of an exemplary charging device.

FIG. 6 is detail view of an embodiment of an exemplary charging device.

FIG. 7 is detail view of an embodiment of an exemplary charging device.

FIG. 8 is a view of the mounting base of the charging system of FIG. 1.

### DETAILED DESCRIPTION OF THE INVENTION

The embodiments described herein relate generally to charging stations for charging an electrically powered vehicle. More specifically, the embodiments described herein relate to charging stations having housings configured to be removably coupled to a surface.

In some embodiments, the term “electric vehicle” refers generally to a vehicle that includes one or more electric motors. Energy used to power the motors may come from various sources, such as, but not limited to, an on-board rechargeable battery and/or an on-board fuel cell. In one embodiment, the electric vehicle is a hybrid electric vehicle, which captures and stores energy generated, for example, by braking. A hybrid electric vehicle uses energy stored in an electrical source, such as a battery, to continue operating when idling to conserve fuel. Some hybrid electric vehicles are capable of recharging the battery by plugging into a power receptacle, such as a power outlet. Accordingly, the term “electric vehicle” as used herein may refer to a hybrid electric vehicle or any other vehicle to which electrical energy may be delivered, for example, via the power grid.

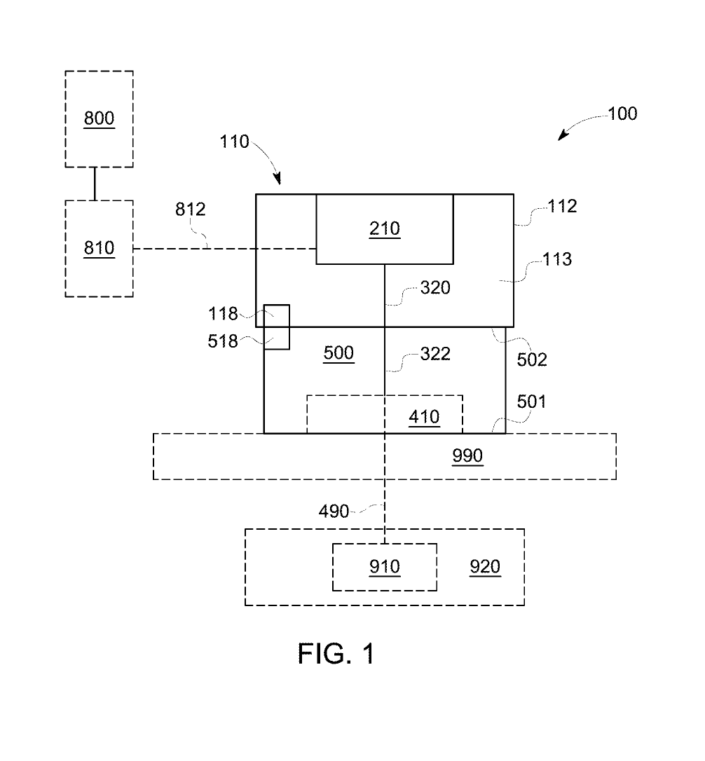

FIG. 1 illustrates in schematic form an exemplary surface mountable charging system 110 for use in charging a power storage device 910 such as a battery of an electrically powered vehicle 920.

A shown in FIG. 1, the charging system 110 comprises a charging device or station 100 which is constructed and arranged to provide power to an electric vehicle from a dedicated electric power source 800. For example, the charging device 100 may be coupled to an electrical distribution device 810 through a power conduit 812. In an exemplary embodiment, the electrical distribution device 810 is a transformer 810 that adjusts a distribution voltage received from the electric power source 800 to a voltage suitable for use with charging device 100. Alternatively, electrical distribution device 810 may be any other device that enables charging system 110 to function as described herein.

The charging device 100 includes an electrical enclosure or housing 112 and a supply circuit 210 coupled to and disposed within the housing 112 and adapted to receive power from the power source 800. For example, the supply circuit 210 may be adapted for Level I or Level II type charging. Charging device 100 also comprises a power connector 320 coupled to the electric vehicle supply circuit 210 and adapted for a removable connection to an electrical wiring receptacle 410, such as a conventional multi-prong, or multi-slot, wall socket or outlet which may be mounted to a surface 990 such as a wall or column. The power connector 320 comprises an end portion 322 adapted to electrically couple with the receptacle 410 to enable current flow from the dedicated electric power source 800 to the receptacle 410. For example, the power connector end portion 322 may comprise a conductive member sized and arranged for insertion into a slot defined on the receptacle 410 to operatively couple with a corresponding receptacle conductor disposed within the slot. Similarly in other embodiments, the power connector end portion 322 may comprise a conductive member sized and arranged to operatively receive a conductive member arranged to protrude from the receptacle 410. The receptacle 410 may be conventionally coupled to the electric storage device 910 via a conductor 490 such as an insulated copper cable. The charging system 110 also comprises a mounting base 500 configured to be coupled or mounted to the mounting surface 990.

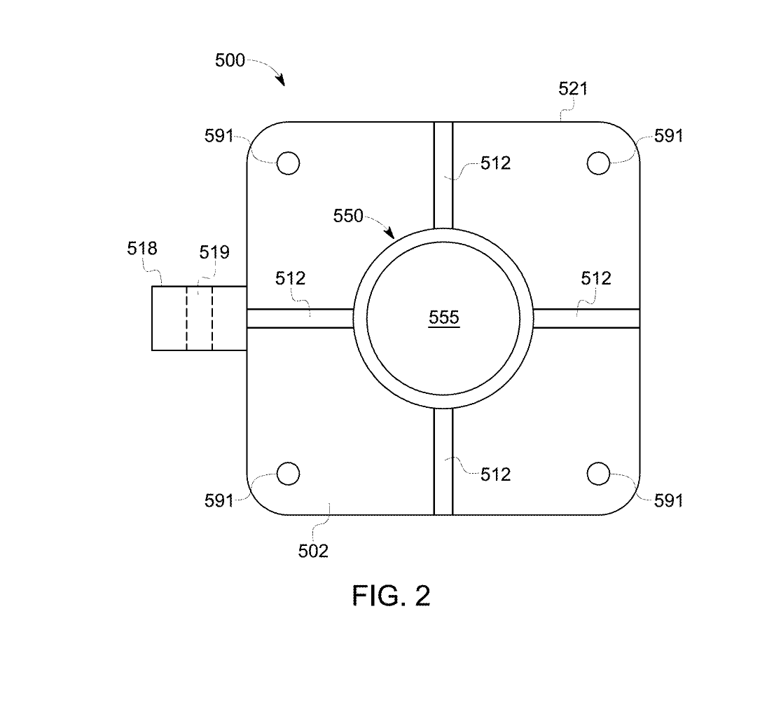

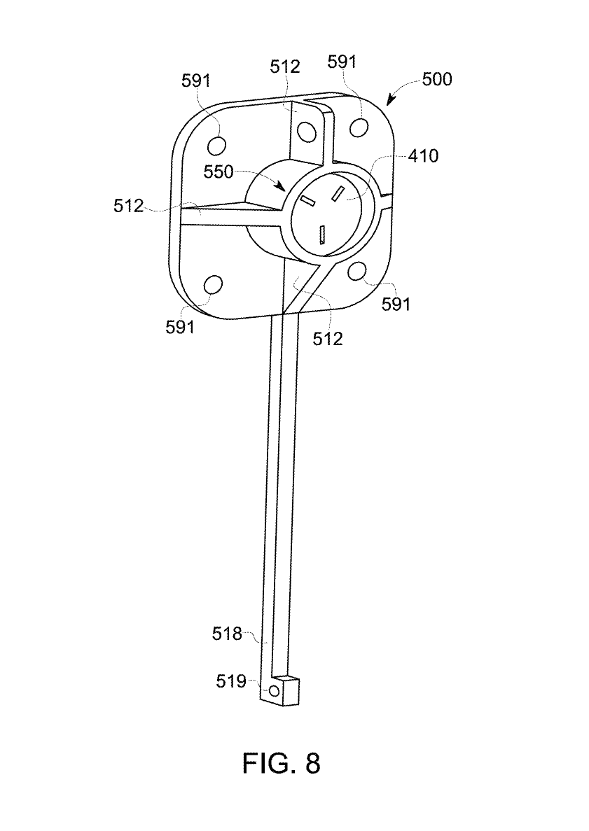

As illustrated in FIG. 2, the mounting base 500 comprises a first coupling portion 550 defining a coupling aperture 555 sized and disposed to operatively receive said power connector 320 therethrough. For example, the first coupling portion 550 may comprise a wall surface oriented to be operatively orthogonal to the mounting surface 990, and defining the coupling aperture 555 therethrough. In an embodiment, the housing 112 may define a mounting base aperture 159, sized and disposed to operatively receive the first coupling portion 550 therein. In an embodiment as illustrated in FIG. 8, the coupling aperture 555 may additionally be sized and disposed to receive the receptacle 410 therein, and to receive power connector 320 to allow an operative electrical connection between the power connector 320 and the receptacle 410. In some embodiments, the electric vehicle supply circuit 210 and the power connector 320 may be adapted for one of AC Level 1 or Level 2 vehicle charging.

In various embodiments, the housing 112 defines a housing interior 113. The electric vehicle supply circuit 210 is positioned within the housing interior 113 and comprises multiple vehicle charging components (not shown). Electric vehicle charging components may include, without limitation, power conduits, transmission lines, power converters, power conditioners, circuit breakers, switching devices, or other components used to provide an energy transfer from charging station 110 to the storage device 910. Housing 112 is configured to at least partially enclose the vehicle charging components to protect such components from various environmental conditions, such as, for example, weather, debris, insects, and rodents, and/or to inhibit unauthorized access to vehicle charging components.

The housing 112 is configured to be operatively coupled to, or mounted on, the mounting base 500. The mounting base 500 may provide mechanical support to the housing 112. As described more fully herein, the mounting base 500 cooperates with the housing 112 to enable an operative electrical connection between the power connector 320 and the receptacle 410. As also described more fully herein, the mounting base 500 and the housing 112 are operatively arranged to cooperate with a locking element 951, such as the hasp of a lock 951a (ref. FIG. 7), to prevent a de-coupling of the housing 112 from the mounting base 500.

The mounting base 500 is configured to be operatively and securely mounted to the mounting surface 990. Mounting holes 591 may be sized to receive a fastener and positioned at any suitable location on the mounting base 500. In an embodiment, the mounting base 500 is configured to be coupled to the wall 990 using fasteners 590 such as screws or nails. In some embodiments, the mounting holes 591 may be disposed on standard spacing to align with wall studs or other suitable structure.

In an embodiment, the mounting base 500 comprises a body portion 521. The body portion 521 comprises at least a mounting base first side 501 and a mounting base second side 502 and may be any suitable size and shape. In an embodiment, the body portion 521 of the mounting base 500 may be operatively disposed between the mounting surface 990 and the housing 112. When in operation, the mounting base first side 501 may be oriented to face the mounting surface 890, and the mounting base second side 502 may be oriented to face the charging device 110.

In an embodiment, the housing 112 is operatively coupled to the mounting base 500 proximal the housing second side 502 and the charging station 110 is electrically coupled to the receptacle 410 via power connector 320. For example, to enable the housing 112 to be coupled to, or mounted on the mounting base 500, the housing 112 may comprise one or more engaging tabs (not shown) disposed thereon and sized and arranged for an operative engagement with corresponding slots (not shown) disposed on the mounting base. The housing 112 may be further or alternatively secured to the mounting base 500 with screws, clips or any other suitable fasteners (not shown).

In an embodiment, the coupling aperture 550 may additionally be sized and disposed to receive the receptacle 410 therein and to receive power connector 320 to allow an operative electrical connection between the power connector 320 and the receptacle 410.

The power connector 320 is electrically coupled to the electric vehicle supply circuit 210. The power connector 320 comprises at least one end portion 322 arranged to operatively couple to the receptacle 410, to provide power from the power source 800 to the receptacle 410. In an embodiment, the power connector 320 may comprise a plurality of conductors each having an end portion 322 sized and disposed for a releasable electrical connection with a conventional electrical receptacle. In an embodiment, the end portion 322 is arranged to protrude or extend from housing 112 and to be received in the coupling aperture 555 of mounting base 500, and to be operatively electrically coupled with the receptacle 410, for example by inserting the end portion 322 into slots 411 defined in the receptacle 410. In various embodiments, to avoid exposing users to live electrical parts, when charging device 100 is operatively installed, the mounting base 500 and coupling aperture 555 are arranged to insulate or enclose power connector 320 to prevent user access to power connector 320. In other embodiments, the end portion 322 of the power connector 320 is recessed within housing 112.

The mounting base 500 is configured to cooperate with the housing 112 and the receptacle 410 to prevent a decoupling of the charging station 110 from the receptacle 410. In an embodiment, the housing 112 comprises a first locking portion 118, and the mounting base 500 comprises a corresponding second locking portion 518. The first and second locking portions 118, 518 are arranged and disposed to cooperate to prevent a decoupling of the power conductor 320 from the receptacle 410. For example, in one embodiment, the first locking portion 118 comprises a first locking aperture 119 defined therethrough, and the second locking portion 518 comprises a second locking aperture 519 defined therethrough. In an embodiment, first and second locking apertures 119, 519 are sized and arranged to cooperatively receive the locking element 951 to prevent an inadvertent or unauthorized decoupling of the charging device 110 from the receptacle 410.

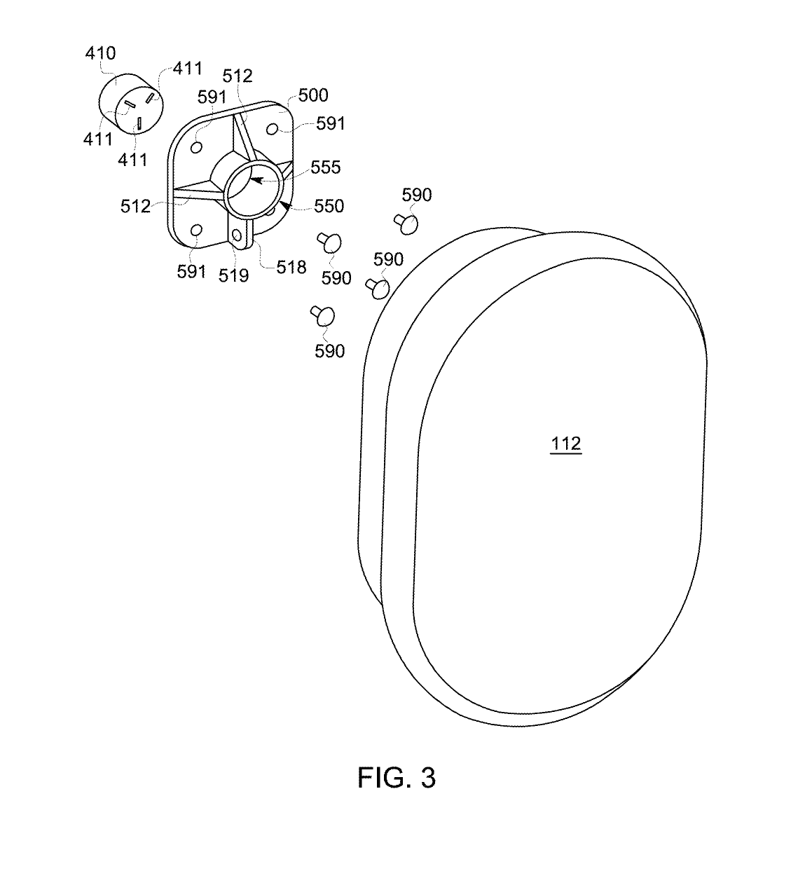

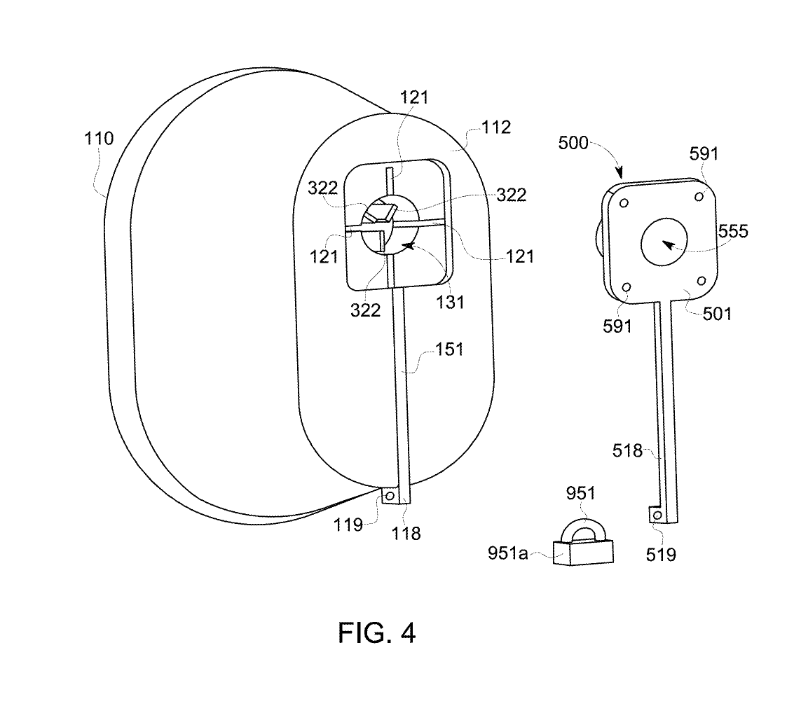

In another exemplary embodiment, and as illustrated in FIGS. 2 through 4, the second locking portion 518 may also be arranged and disposed to extend from body portion 521. The housing 112 may comprise a corresponding locking member recess 151 sized and disposed to receive at least a portion of the first locking portion 518. While the figures illustrate the mounting base 500 to be narrower than the enclosure 112, in other embodiments the mounting base 500 may be the same width as, or wider than, the enclosure 112.

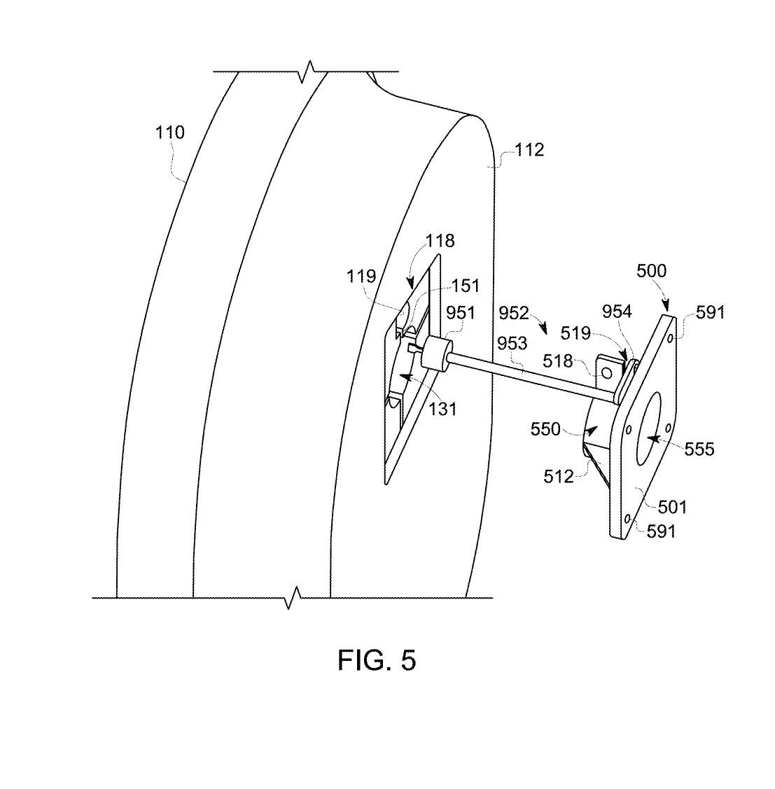

In another embodiment, the locking element 951 may comprise a latching portion 952. In such an embodiment, the locking aperture 119 is arranged to operatively receive at least a portion of the locking element 951. For example, as illustrated in FIG. 5, the latching portion 952 of locking element 951 may comprise a lock shaft 953 and a latch 954. In such an embodiment, the second locking aperture 519 is sized and arranged to operatively receive the latch 954 to prevent an inadvertent or unauthorized decoupling of the charging device 110 from the receptacle 410. The locking element 951 is operative to rotate the lock shaft 953 in a first locking direction to engage the latch 954 in the locking aperture 519; and operative to rotate the lock shaft 953 in a second unlocking direction to disengage the latch 954 from the locking aperture 519. In some embodiments, the first direction is opposite the second direction. For example, a user may use a key or other tool to engage the locking element 951 and to turn the locking element 951 in at least on one of the first locking direction and the second unlocking direction.

In an embodiment, the housing 112 comprises at least one housing alignment feature 121 arranged and disposed to guide placement of the housing 112 over the mounting base 500 and into operable communication with the receptacle 410 during an installation of the charging device 110. Additionally, in an embodiment, the mounting base 500 comprises a corresponding at least one mounting base alignment feature 512 arranged to cooperate with the at least one housing alignment feature 112. Once the housing 112 is installed or mounted on the mounting base 500, the at least one housing alignment feature 121 may cooperate with the corresponding at least one mounting base alignment feature 512 to prevent a rotational movement of the housing 112 with respect to the mounting base 500.

For example, in the embodiment shown in FIG. 2, the housing alignment member 121 comprises at least recessed area such as a slot, and the mounting base alignment feature 512 comprises at least one corresponding raised area such as a rib. In other embodiments, the housing alignment member 121 may comprise at least one slot (not shown), and the mounting base alignment feature 512 comprises at least one corresponding rib (not shown). In still other embodiments, any desired combination of housing alignment member ribs and/or slots may cooperate with any desired combination of corresponding mounting base alignment slots and/or ribs that enables the charging device 110 to function as described herein.

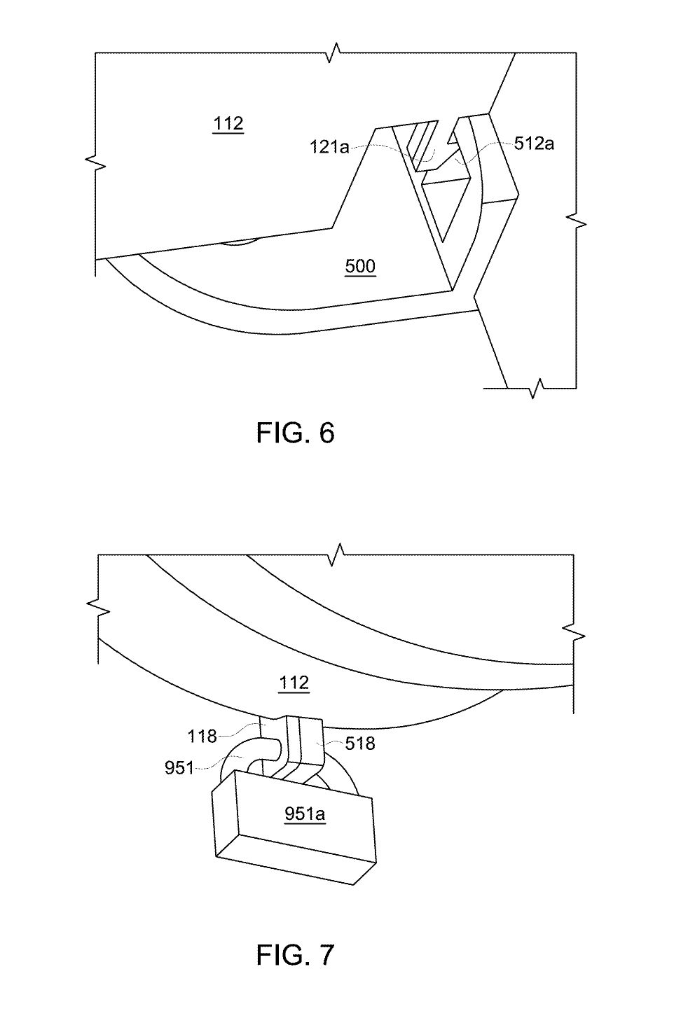

As illustrated in FIG. 6, in yet another embodiment, the at least one the housing alignment member 121 comprises a resilient member 121a having a hook-shaped profile. In such an embodiment, the mounting base alignment feature 512 defines at least one corresponding aperture 512a, sized and disposed to releasably receive the at least one mounting base resilient member 121c. In other embodiments, (not shown) the mounting base alignment feature 512 comprises at least one resilient member having a hook-shaped profile. In such an embodiment, the housing alignment member 121 defines at least one corresponding aperture sized and disposed to releasably receive the at least one mounting base alignment feature 512.

Additionally, the housing 112 may comprise a recessed area 131 sized and disposed to at least partially receive a portion of the housing second side 502. For example, in an embodiment, the recessed area 131 is sized to allow a predetermined portion of the housing 112 to operatively contact the mounting surface 890. In such an embodiment, once the housing 112 is installed or mounted on the mounting base 500 the housing 112 may also be rigidly secured to the mounting surface 890 with fasteners (not shown), such as screws.

Moreover, in exemplary embodiments, the housing 112 and the mounting base 500, are constructed from rigid material such as plated or stainless steel to provide adequate strength and inhibit corrosion. In other examples, one or more other materials may be used to form the housing 112 and the mounting base 500, provided the material(s) is sufficiently rigid and/or stiff to perform as described herein.

In an exemplary embodiment, by fixedly coupling the mounting base 500 to the desired mounting surface 990 proximal to the receptacle 410 and such that the coupling aperture 555 is disposed to receive power connector 320 to allow an operative electrical connection between the power connector 320 and the receptacle 410; and fixedly coupling the housing 112 to the mounting base 500, the charging device 100 may be easily electrically coupled to the desired receptacle 410, and subsequently easily removed for maintenance, without special tools. For example, in an embodiment, the charging device 100 may be mounted to the desired mounting surface 990 for operation by coupling the mounting base 500 to the mounting surface 990 proximal to the receptacle 410, by using fasteners such as screws, then disposing the housing 112 proximal to the mounting base 500, aligning the at least one housing alignment feature 121 proximal to the at least one mounting base alignment feature 512, and then moving the housing 112 to thereby electrically couple the power connector 320 to the receptacle 410 and to align the first and second locking apertures 119, 519 to receive locking element 951 to prevent an inadvertent or unauthorized decoupling of the charging device 100 from the receptacle 410. The locking element 951 may be disposed in the first and second locking apertures 119, 519 to prevent unauthorized decoupling of the charging device 100 from the receptacle 410. Conversely, the surface mountable charging station 100 may be subsequently be removed from the mounting surface 990 without special tools, such as for maintenance, by removing the locking element 951 and decoupling the housing 112 from the mounting base 500 and receptacle 410.

In the above described manner, a user is permitted to remove the charging device 100 from receptacle 410 and to access the interior of the housing 112 for maintenance or repair. Accordingly, given configuration, size, and/or shape constraints often associated with surface mountable charging device 100, a user is provided with improved access to vehicle charging components within the housing 112, as compared to known charging stations.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is clamed is:

1. An electric vehicle charging device, mountable to a mounting surface and connectable to a power receptacle, said charging device comprising:
a housing 112, said housing comprising an interior portion 113 and a first locking portion 118 defining a first locking aperture 119 therethrough;
an electric circuit 210 configured to supply a charging current to an electric vehicle power storage device, said electric circuit disposed at least partially within said housing interior portion 113;
a power connector 320 electrically coupled to said electric circuit 210, comprising an end portion 322 configured for a releasable electrical connection with the power receptacle 410;
a mounting base 500 configured to be mounted to the mounting surface 990, said mounting base 500 comprising:
a first coupling portion 550 defining a coupling aperture 555 defined therethrough, sized and disposed to operatively receive said power connector 410;
a second locking portion 518, said second locking portion defining a second locking aperture 519;
wherein said housing 112 is configured to be operatively coupled to said mounting member 500; and
wherein said first and second locking apertures 119, 519 are sized and disposed to cooperate with a locking element 951 to prevent a de-coupling of said housing 112 from said mounting member 500.

2. The charging device of claim 1, wherein said housing includes a first alignment feature, and said mounting member includes a second alignment feature, wherein said first alignment feature is sized and disposed to operatively mate with said second alignment feature.

3. The charging device of claim 2, wherein said first guide member is one of a rib or a slot, and said second guide member is the other of a rib and a slot.

4. The charging device of claim 2, wherein said first guide member is one of a resilient member and an aperture, and said second guide member is the other of a resilient member and an aperture.

5. The charging device of claim 1, wherein said electric circuit is adapted for one of a Level I or Level II charging.

6. The charging device of claim 1 wherein the coupling aperture is further sized to operably receive the power connector

7. The charging device of claim 1, wherein said mounting base further comprises a body portion, and wherein said second locking portion extends from said body portion.

8. The charging device of claim 7, wherein said housing further comprises a corresponding locking member recess sized and disposed to receive at least a portion of the first locking portion.

9. The charging device of claim 1, wherein said housing further comprises a recessed area sized and disposed to at least partially receive a portion of the housing second side.

10. The charging device of claim 9, wherein said recessed area is sized to allow a predetermined portion of the housing to operatively contact the mounting surface.

11. A charging system, mountable to a mounting surface connectable to a power receptacle, said charging system comprising:
a housing 112, said housing comprising an interior portion 113 and a first locking portion 118 defining a first locking aperture 119 therethrough;
an electric circuit 210 configured to supply charging current to a power storage device, said electric circuit disposed at least partially within said housing interior portion 113;
a power connector 320 electrically coupled to said electric circuit, comprising an end portion 322 configured for a releasable electrical connection with the power receptacle 410;
a mounting base 500 configured to be mounted to the mounting surface 990, said mounting member comprising:
a first coupling portion 550 defining a coupling aperture 555 therethrough, sized and disposed to operatively receive said power connector 410;
a second locking portion 518, said second locking portion defining a second locking aperture 519 therethrough;
wherein said housing 112 is configured to be operatively coupled to said mounting member 500;
a locking element 951 disposable within said first and second locking apertures 119, 519; and
wherein said first and second locking apertures 119, 519 cooperate with the locking element to selectively prevent a de-coupling of said housing 112 from said mounting member 500.

12. The charging system of claim 11, wherein said housing includes a first alignment feature, and said mounting member includes a second alignment feature, wherein said first alignment feature is sized and disposed to operatively mate with said second alignment feature.

13. The charging system of claim 12, wherein said first guide member is one of a rib or a slot, and said second guide member is the other of a rib and a slot.

14. The charging system of claim 12, wherein said first guide member is one of a resilient member and an aperture, and said second guide member is the other of a resilient member and an aperture.

15. The charging system of claim 11, wherein said electric circuit is adapted for one of a Level I or Level II charging.

16. The charging system of claim 11 wherein the coupling aperture 555 is further sized to operably receive the power connector

17. The charging system of claim 11, wherein said mounting base 500 further comprises a body portion, and wherein said second locking portion 518, extends from said body portion.

18. The charging system of claim 17, wherein said housing 112 further comprises a corresponding locking member recess 151 sized and disposed to receive at least a portion of the first locking portion 518.

19. The charging system of claim 11, wherein said housing 112 further comprises a recessed area 131 sized and disposed to at least partially receive a portion of the housing second side 502,

20. The charging system of claim 19, wherein said recessed area 131 is sized to allow a predetermined portion of the housing 112 to operatively contact the mounting surface 890.
